(19) United States
(12) Patent Application Publication
(10) Pub. No.: US 2004/0114882 A1
(43) Pub. Date: Jun. 17, 2004

(54) Low cost integrated heater substrate for active optical fiber alignment

(76) Inventors: Christian L. Marquez, Redondo Beach, CA (US); James C. Lau, Torrance, CA (US); Paul J. Hamilton, Redondo Beach, CA (US)

Correspondence Address: Warn Burgess & Hoffmann PC, P O Box 70098, Rochester Hills, MI, 48307, US

(21) Appl. No.: 10/319,733

(22) Filed: Dec. 12, 2002

(51) Int. Cl. G02B 6/36

(52) U.S. Cl. 385/91

(57) ABSTRACT

An optical packaging assembly (10) for securing an optical fiber (12) to a heater substrate (30) in optical alignment with an opto-electronic device (14). The opto-electronic device (14) is secured to a device substrate (18) in the packaging assembly (10). The heater substrate (30) includes a conductive region (44), resistive elements (52) and a solder platform (42). The optical fiber (12) and a solder preform (32) are positioned on the solder platform (42). A voltage potential is applied to the conductive region (44) to heat the resistive elements (52) to cause the solder preform (32) to melt and secure the optical fiber (12) to the heater substrate (30) in alignment with the opto-electronic device (14). The resistive elements (52) are symmetrically disposed around the solder platform (42) to minimize translational and rotational shifts of the optical fiber (12) to primarily one translational axis of motion when the solder preform (32) cools.

### BACKGROUND OF THE INVENTION

1. Field of the Invention

This invention relates generally to an opto-electronic assembly for aligning an optical fiber to an opto-electronic device and, more particularly, to an opto-electronic assembly employing a thin-film substrate including an integrated heater, where the heater melts a solder preform to secure an optical fiber in optical alignment with an opto-electronic device.

2. Discussion of the Related Art

High data rate optical communications systems typically require that an optical fiber or optical waveguide be actively aligned to an opto-electronic device, such as a photoemitter or photodetector, at the applicable locations in the system. Active alignment of an optical fiber to an opto-electronic device uses a sensing system having a feedback loop to indicate that the optical fiber is in precise alignment with the opto-electronic device within minimum tolerances. Passive optical alignment techniques can be employed in low data rate applications where less demanding positional alignment tolerances between the fiber and the opto-electronic device are required. Once the optical fiber is aligned to the opto-electronic device, the optical fiber is permanently attached to a substrate, housing or some other optical device packaging.

Various techniques are known in the art for securing an optical fiber to a substrate in optical alignment with an opto-electronic device. These techniques usually must be low cost, highly reliable and highly repeatable to satisfy a particular manufacturing process. The known alignment techniques include laser welding the optical fiber ferrule in alignment with the opto-electronic device, using an epoxy to glue the optical fiber in alignment with the opto-electronic device, and soldering the optical fiber in alignment with the opto-electronic device.

Epoxy alignment techniques typically offer low cost and highly repeatable alignment capabilities that are generally suitable for alignment applications that do not require high precision. However, epoxy alignment techniques are typically less robust than laser welding and soldering, and provide higher coefficients of thermal expansion between the epoxy and the substrate that affect the ability to accurately align the fiber to the opto-electronic device.

Laser welding alignment techniques typically provide high precision alignment for low tolerance applications. Additionally, laser welding techniques offer the ability to make minor corrections of the alignment once the optical fiber has been welded to the substrate. However, laser welding alignment techniques are typically high cost because of the many expensive components that are required for the process and the long duration of the alignment cycle time.

Soldering techniques for securing an optical fiber to a substrate in alignment with an opto-electronic device is the most popular technique for providing a high volume optical alignment process. Benefits of soldering alignment techniques include relatively low cost, high robustness, short processing time and high repeatability. However, known soldering alignment techniques for aligning an optical fiber to an opto-electronic device usually cannot provide all of the following: localizing the heat to the fiber attachment area within the optical assembly so as to not damage nearby heat sensitive components, applying the heat uniformly at the fiber attachment area to minimize and control fiber shift during solder cooling, and employing low-cost, standard materials and processes commonly used in electronic and opto-electronic packaging.

### SUMMARY OF THE INVENTION

In accordance with the teachings of the present invention, a soldering technique and related hardware is disclosed for securing an optical waveguide to an optical packaging assembly in optical alignment with an opto-electronic device. The opto-electronic device is secured to a device substrate in the packaging assembly by epoxy or the like. A heater substrate is secured to the packaging assembly relative to the device substrate. The heater substrate includes conductive regions, a plurality of resistive elements and a solder platform. A solder preform and the optical waveguide are positioned on the solder platform and secured thereto in optical alignment with the opto-electronic device. In one embodiment, the resistive elements are symmetrically disposed around the solder platform to minimize the translational and rotational shifts of the optical fiber to primarily one translational axis of motion when the solder preform cools.

The optical waveguide and the solder preform are positioned on the solder platform by a suitable pick and place device in rough alignment with the opto-electronic device. A voltage potential is applied to the conductive regions on the heater substrate to heat the solder preform. An active optical alignment system is used to align the waveguide to the opto-electronic device. The voltage potential is removed from the conductive regions to allow the solder preform to cool and rigidly secure the optical waveguide to the platform in alignment with the opto-electronic device. The active alignment compensates for movement of the fiber as the solder cools.

Additional objects, advantages and features of the present invention will become apparent from the following description and appended claims, taken in conjunction with the accompanying drawings.

### BRIEF DESCRIPTION OF THE DRAWINGS

FIG. 1 is a cut-away, perspective view of an optical packaging assembly including an optical fiber mounted to a heater substrate in alignment with an opto-electronic device, according to an embodiment of the present invention; and

FIG. 2 is a side view of the assembly shown in FIG. 1;

FIG. 3 is a top view of the heater substrate removed from the assembly shown in FIG. 1;

FIG. 4 is a top view of a heater substrate, according to another embodiment of the present invention, applicable to be used in the packaging assembly shown in FIG. 1;

FIG. 5 is a cross-sectional view of the heater substrate shown in FIG. 4; and

FIG. 6 is a partial cross-sectional view of an optical packaging assembly including an optical fiber mounted to a heater substrate in alignment with an opto-electronic device, according to another embodiment of the present invention.

### DETAILED DESCRIPTION OF THE EMBODIMENTS

The following discussion of the embodiments of the invention directed to a soldering technique for aligning an optical fiber to an opto-electronic device is merely exemplary in nature, and is in no way intended to limit the invention or its applications or uses.

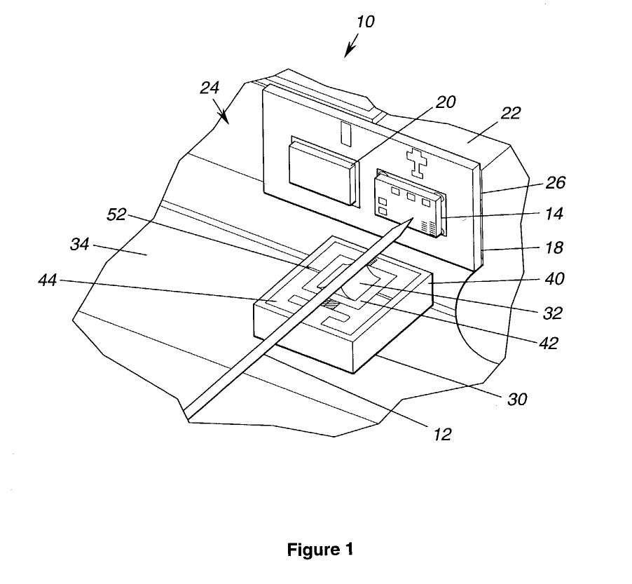

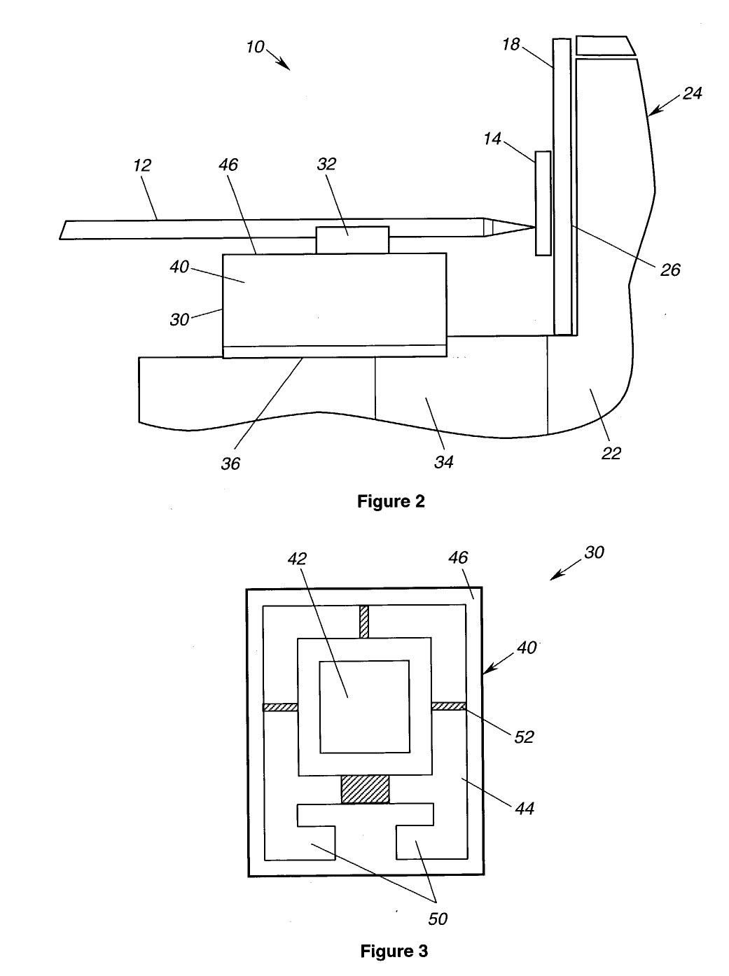

FIG. 1 is a perspective view and FIG. 2 is a side view of an optical packaging assembly 10 that holds an optical fiber 12 in alignment to an opto-electronic device 14. The opto-electronic device 14 can be any suitable optical detector or optical emitter, such as a photodetector or a light emitting diode (LED), employed in an optical communications system. Additionally, the optical fiber 12 can be any suitable optical fiber for such an optical system, such as a single mode or a multi-mode optical fiber. In alternate embodiments, the optical fiber 12 can be mounted within a protective ferrule, or can be other optical waveguides having different shapes, such as rectangular.

As will be discussed in detail below, a soldering process and related hardware of the invention provide a highly accurate process for aligning the fiber 12 to the device 14 within very small tolerances. Additionally, the soldering process of the invention provides a short processing time and is very robust and repeatable.

The opto-electronic device 14 is mounted to a substrate 18 in any suitable manner. Various other optical or electronic devices 20 associated with the particular system are also mounted to the substrate 18. The substrate 18 is mounted to a sidewall 22 of an assembly housing 24 by a suitable solder layer or adhesive layer 26. The housing 24 is made of any material and has any size and configuration suitable for the purposes discussed herein.

According to the invention, the optical fiber 12 is soldered to a thin-film integrated heater substrate 30 by a solder preform 32. The solder preform 32 can be any solder material suitable for the purposes described herein, such as an AuSn solder. The heater substrate 30 is soldered or glued to a base plate 34 of the housing 24 by a solder or adhesive layer 36. Once the substrate 30 is secured to the base plate 34, the soldering alignment technique of the invention secures the fiber 12 to the substrate 30 in optical alignment with the device 14. In this design, the optical fiber 12 is metalized to be readily secured to the solder preform 32. In alternate designs, the optical fiber 12 can be inserted into an optical ferrule (not shown), and the ferrule can be secured to the heater substrate 30 by the solder preform 32.

FIG. 3 is a top view of the heater substrate 30 removed from the assembly 10. The heater substrate 30 includes a substrate base 40 made of a suitable material, such as alumina. A conductive region 44 is deposited and patterned on a top surface 46 of the base 40 by any suitable fabrication process, such as vacuum deposition, electroplating, sputtering, etching, etc. In one embodiment, the conductive region 44 is made of a titanium/tungsten/gold alloy, but can be any conductive material suitable for the purposes described herein. The conductive region 44 defines electrodes 50 to which a DC voltage or current potential is applied to heat the substrate 30, and included a central region 42 to which the solder perform 32 (FIG. 2) is attached.

A series of resistive elements 52 are patterned on the conductive region 44, as shown. In this embodiment, the resistive elements 52 are four rectangular elements symmetrically disposed on the conductive region 44. However, this is by way of a non-limiting example in that other numbers and shapes of resistive elements can be employed within the scope of the present invention. Additionally, the resistive elements 52 can be made of any resistive material suitable for the purposes described herein, such as tantalum nitride.

When the voltage or current potential is applied to the electrodes 50, the resistive elements 52 heat up, and the heat is transferred to the solder platform 42 to cause the solder preform 32 to melt. The voltage or current potential can be any suitable voltage or current potential that provides the proper heating of the solder preform 32 without adversely effecting other components of the assembly 10. In one embodiment, a heater resistance of 1 ohm would allow 5 amps of current to generate 25 watts of heating power. Also, the soldering process of the invention provides localized heating to the desired location to limit the effects of the heat on other components in the assembly 10.

In this embodiment, the heater substrate 30 is designed so that the resistive elements 52 are symmetrically disposed around the solder platform 42 to uniformly distribute the heat. This configuration minimizes the translational and rotational shifts of the fiber 12 to primarily one translational axis of motion when the voltage or current potential is removed and the solder preform cools. This translational axis of motion can be designed to be along the longitudinally axis of the fiber 12 to minimize the effect. This one axis of motion can be experimentally characterized so that the position of the fiber 12 can be compensated for before applying the voltage potential to consistently achieve optimal alignment once the soldering process is complete. The heater substrate 30 requires no special or extraordinary materials, processes or equipment, making it a low-cost soldering approach. Further, the heater substrate 30 effectively localizes the heat, so as to not damage heat sensitive components located near the heater substrate 30.

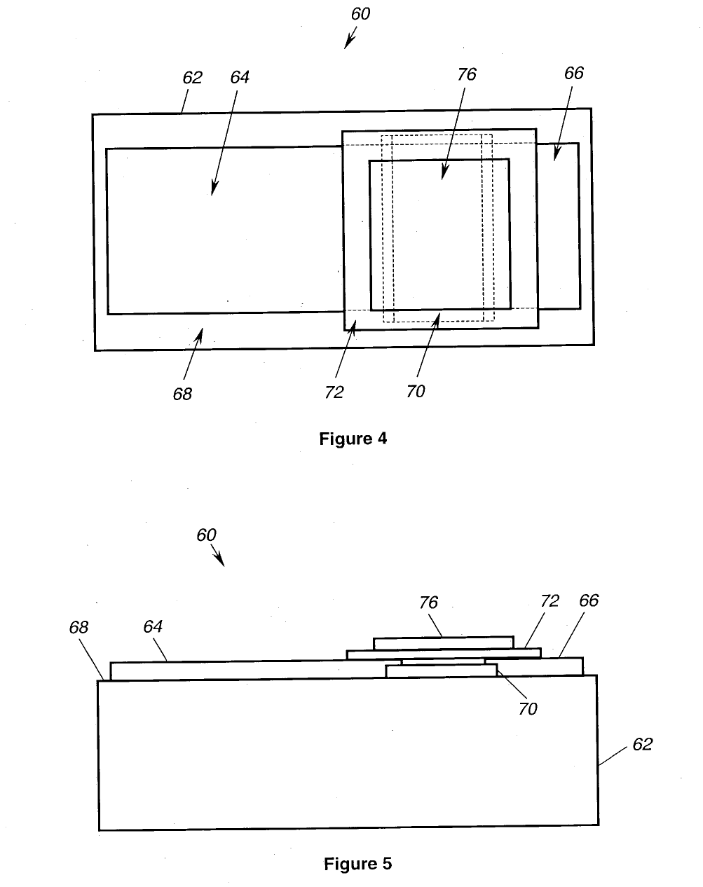

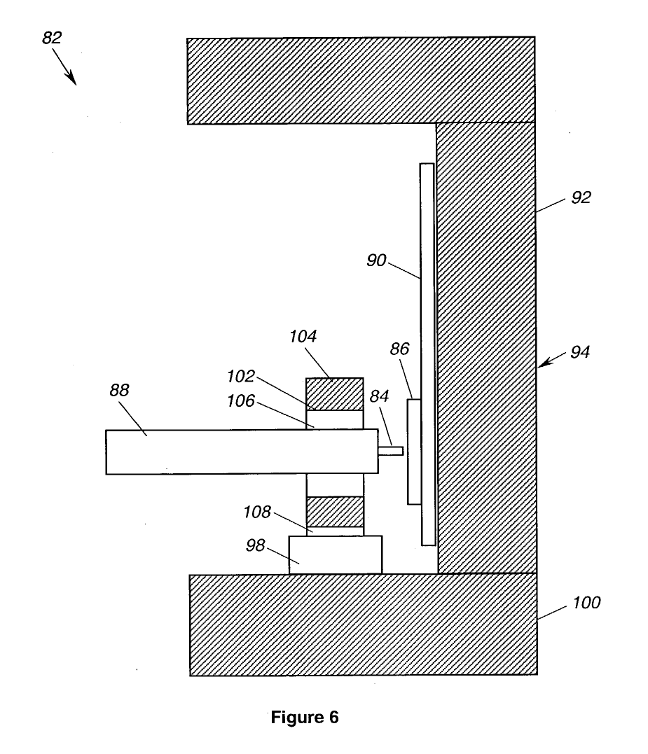

FIG. 4 is a top view and FIG. 5 is a side view of a thin-film integrated heater substrate 60, according to another embodiment of the present invention, that can replace the heater substrate 30 in the packaging assembly 10 discussed above. The similar components of the heater substrate 60 to the heater substrate 30 can be made of the same materials as discussed above. A thin-film resistive element 70 is deposited on a top surface 68 of a base 62 of the substrate 60. A pair of conductive regions 64 and 66 are patterned on the top surface 68 of the base 62, and overlap opposing edges of the resistive element 70, as shown, so that there is a space between the conductive regions 64 and 66. An insulator layer 72 is patterned on the conductive regions 64 and 66, and extends over the space defined therebetween. A solder platform 76 is mounted on the insulator layer 72 and is applicable to accept the solder preform 32. As above, a voltage potential is applied to the conductive regions 64 and 66 to heat the resistive element 70. The heat generated by the resistive element 70 is conducted through the insulator layer 72 to heat the solder platform 76 and melt the solder preform 32.

The fiber alignment and attachment process includes an automated pick and place device (not shown) that positions all of the components into the housing 24 and secures them in place either using solder or epoxy, as discussed above. The pick and place device positions the solder preform 32 on the heater substrate 30. The pick and place device inserts the fiber 12 into the housing 24, typically through a metal tube, and then grips the fiber 12 to hold it in rough alignment with the device 14. A voltage potential is then applied to the electrodes 50 to melt the solder preform 32. In one embodiment, the electrical current that provides the voltage potential can be transmitted through the pick and place tool. The applied voltage may be kept as low as 10 volts so that there should be no ESD concerns. The fiber 12 is brought down so that the molten solder can wet the metalized outer portion of the fiber 12. The fiber 12 is then actively aligned using an optical feedback loop, known to those skilled in the art, and then moved a calculated distance to compensate for movement of the fiber 12 during solder cooling. The voltage potential is removed, and the solder cools and solidifies, bringing the fiber 12 into precise optical alignment with the device 14.

FIG. 6 is a partial cross-sectional view of an optical packaging assembly 82 that aligns an optical fiber 84 to an opto-electronic device 86, according to another embodiment of the present invention. In this embodiment, the fiber 84 is positioned within a ferrule 88 having an outer metalized layer. The opto-electronic device 86 is mounted to a device substrate 90 by a suitable adhesive or the like, and the substrate 90 is mounted to a sidewall 92 of a housing 94, in the manner as discussed above.

According to the invention, the fiber 84 is aligned to the opto-electronic device 86 by a solder alignment technique employing an integrated heater substrate 98. The heater substrate 98 is secured to a base plate 100 of the housing 94 by a suitable epoxy or adhesive layer. The heater substrate 98 can be the heater substrate 30 or the heater substrate 60, discussed above, or any other heater substrate consistent with the discussion herein.

In this embodiment, the ferrule 88 is positioned within a center opening 102 of an annular positioning ring 104, as shown. An annular solder preform 106 is positioned around the ferrule 88 within the opening 102 of the ring 104. The ring 104 is secured to a solder platform (not shown) of the heater substrate 98 by an adhesive or epoxy layer 108. A suitable pick and place device can secure the various components discussed herein during the soldering process.

A voltage potential is applied to the electrodes of the heater substrate 98 to melt the solder preform 106. An active alignment system is used that positions and holds the ferrule 88 in optical alignment with the opto-electronic device 86 as the solder preform 106 melts. Once the optical fiber 84 is in alignment, the voltage potential is removed from the heater substrate 98 so that the solder preform 106 cools and hardens to hold the fiber 84 in optical alignment. The optical alignment process compensates for movement of the ferrule 88 as a result of the cooling of the solder preform 106.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. An optical assembly for securing an optical waveguide in alignment with an optical device, said assembly comprising:
a housing;
a device substrate mounted to the housing, said optical device being mounted to the device substrate; and
a heater substrate mounted to the housing, said heater substrate including a base, a plurality of spaced apart resistive elements mounted to the base, at least one electrical contact mounted to the base and a solder preform mounted on the base, said optical waveguide being positioned on the heater substrate in contact with the solder preform, wherein a voltage or current potential is applied to the at least one electrical contact to heat the resistive elements to melt the solder preform and secure the waveguide to the heater substrate in alignment with the optical device.

2. The assembly according to claim 1 wherein the plurality of resistive elements are symmetrically disposed around the solder preform.

3. The assembly according to claim 2 wherein the plurality of resistive elements is four elements.

4. The assembly according to claim 2 wherein the plurality of resistive elements is a plurality of rectangular resistive elements.

5. The assembly according to claim 1 wherein the heater substrate further includes a solder platform, said solder preform and said optical waveguide being mounted on the solder platform.

6. The assembly according to claim 1 wherein the plurality of resistive elements are disposed on the base in a configuration that causes the optical waveguide to only move in one translational axis of motion when the solder preform cools after being melted.

7. The assembly according to claim 1 wherein the optical waveguide extends through a center opening of an annular positioning ring, said positioning ring being mounted to the heater substrate and said solder preform being positioned within the opening of the ring around the waveguide.

8. The assembly according to claim 1 wherein the optical waveguide is an optical fiber.

9. The assembly according to claim 8 wherein the optical fiber is positioned within a ferrule.

10. The assembly according to claim 1 wherein the optical device is an opto-electronic device.

11. An optical assembly for securing an optical fiber in alignment with an opto-electronic device, said assembly comprising:
a housing;
a device substrate mounted to the housing, said opto-electronic device being mounted to the device substrate; and
a heater substrate mounted to the housing, said heater substrate including a base, a conductive region disposed on the base, a solder platform disposed on the base and a plurality of resistive elements symmetrically disposed around the solder platform on the base, said heater substrate further including a solder preform positioned on the solder platform in contact with the optical fiber, wherein a voltage potential is applied to the conductive region to heat the resistive elements to melt the solder preform and secure the fiber to the heater substrate in alignment with the opto-electronic device.

12. The assembly according to claim 11 wherein the plurality of resistive elements is four rectangular resistive elements.

13. The assembly according to claim 11 wherein the plurality of resistive elements are disposed on the base in a configuration that causes the optical fiber to only move in one translational axis of motion when the solder preform cools after being melted.

14. The assembly according to claim 11 wherein the optical fiber is positioned within a ferrule.

15. An optical assembly for securing an optical waveguide in alignment with an optical device, said assembly comprising:
a housing;
a device substrate mounted to the housing, said optical device being mounted to the device substrate; and
a heater substrate mounted to the housing, said heater substrate including a base, a conductive region formed on the base, at least one resistive element formed on the base and a solder preform positioned on the base, said optical waveguide being positioned on the heater substrate in contact with the solder preform, wherein a voltage potential is applied to the conductive region to heat the at least one resistive element to melt the solder preform and secure the waveguide to the heater substrate in alignment with the optical device, said at least one resistive element being positioned on the heater substrate at a location that causes the waveguide to move in only one translational axis of motion when the solder preform cools after the voltage potential is removed.

16. The assembly according to claim 15 wherein the at least one resistive element in a plurality of resistive elements symmetrically disposed around the solder preform.

17. The assembly according to claim 15 wherein the optical waveguide is an optical fiber and the optical device is an opto-electronic device.

18. A method of soldering an optical fiber to an optical assembly in alignment with an opto-electronic device, comprising:
mounting the opto-electronic device to the assembly;
mounting a heater substrate to the assembly, said heater substrate including a base, a conductive region formed on the base, and a plurality of spaced apart resistive elements formed on the base;
positioning a solder preform on the heater substrate;
positioning the optical waveguide on the heater substrate in contact with the solder preform;
applying a voltage potential to the conductive region to heat the resistive elements and cause the solder preform to melt;
optically aligning the optical fiber to the opto-electronic device; and
removing the voltage potential to allow the solder preform to cool and secure the fiber to the assembly in alignment with the opto-electronic device.

19. The method according to claim 18 wherein optically aligning the optical fiber includes compensating for movement of the optical fiber when the solder preform cools.

20. The method according to claim 18 wherein the resistive elements are positioned on the heater substrate so that the optical fiber only moves in one translational axis of motion when the solder preform cools and hardens.

21. The method according to claim 18 wherein the plurality of resistive elements are symmetrically disposed around the solder preform.
